(19) United States
(12) Patent Application Publication
(10) Pub. No.: US 2013/0150656 A1
(43) Pub. Date: Jun. 13, 2013

(54) INFANT TRANSPORTER APPARATUS

(71) Applicants: Steven Falk, Laurel, MD (US); Thomas Underwood, Laurel, MD (US); Richard Mallozzi, Wilmington, MA (US); Arkadiy Tsitlik, Laurel, MD (US); Karen Starr, Laurel, MD (US)

(72) Inventors: Steven Falk, Laurel, MD (US); Thomas Underwood, Laurel, MD (US); Richard Mallozzi, Wilmington, MA (US); Arkadiy Tsitlik, Laurel, MD (US); Karen Starr, Laurel, MD (US)

(73) Assignee: GENERAL ELECTRIC COMPANY, Schenectady, NY (US)

(21) Appl. No.: 13/324,000

(22) Filed: Dec. 13, 2011

(51) Int. Cl. A61G 11/00

(52) U.S. Cl. 600/22

(57) ABSTRACT

An infant transporter includes a transporter base, a support member secured to the base, and a housing supported by the support member. The housing includes a radio frequency coil adapted to emit a radio frequency configured to enable magnetic resonance imaging. The infant transporter exclusively comprises components that are magnetic resonance imaging compatible.

### BACKGROUND OF THE INVENTION

The subject matter disclosed herein relates to an infant transporter apparatus.

Conventional infant incubators and hybrid incubator/warmers provide a confined enclosure adapted to retain an infant in a controlled environment. A convective heating system generates heated air to regulate temperature within the enclosure. Incubators and hybrid incubator/warmers may also comprise a humidifier configured to regulate the humidity within the controlled environment.

One problem with conventional infant incubators and hybrid incubator/warmers is that they are generally not Magnetic Resonance Imaging (MRI) compatible. It is therefore typically necessary to physically transfer the infant from the incubator or incubator/warmer bed onto the MRI table. The handling and stimulation associated with a conventional bed-to-bed transfer can harm the infant.

### BRIEF DESCRIPTION OF THE INVENTION

The above-mentioned shortcomings, disadvantages and problems are addressed herein which will be understood by reading and understanding the following specification.

In an embodiment, an infant transporter includes a transporter base, a support member secured to the base, and a housing supported by the support member. The housing includes a radio frequency coil adapted to emit a radio frequency configured to enable magnetic resonance imaging. The infant transporter exclusively comprises components that are magnetic resonance imaging compatible.

In another embodiment, an infant transporter includes a transporter base, and a vertically adjustable support member secured to the base. The infant transporter also includes a transporter platform secured to the support member. The transporter platform is translatable relative to the support member. The infant transporter also includes a housing supported by and secured to the transporter platform. The housing comprises a radio frequency coil adapted to emit a radio frequency configured to enable magnetic resonance imaging. The infant transporter exclusively comprises components that are magnetic resonance imaging compatible.

Various other features, objects, and advantages of the invention will be made apparent to those skilled in the art from the accompanying drawings and detailed description thereof.

### BRIEF DESCRIPTION OF THE DRAWINGS

FIG. 1 is an isometric view of an infant transporter in accordance with an embodiment;

FIG. 2 is an isometric view of a hybrid incubator/warmer in accordance with an embodiment;

FIG. 3 is an isometric view of an infant transporter and a hybrid incubator/warmer in accordance with an embodiment; and

FIG. 4 is an isometric view of an infant transporter and a Magnetic Resonance Imaging (MRI) device in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

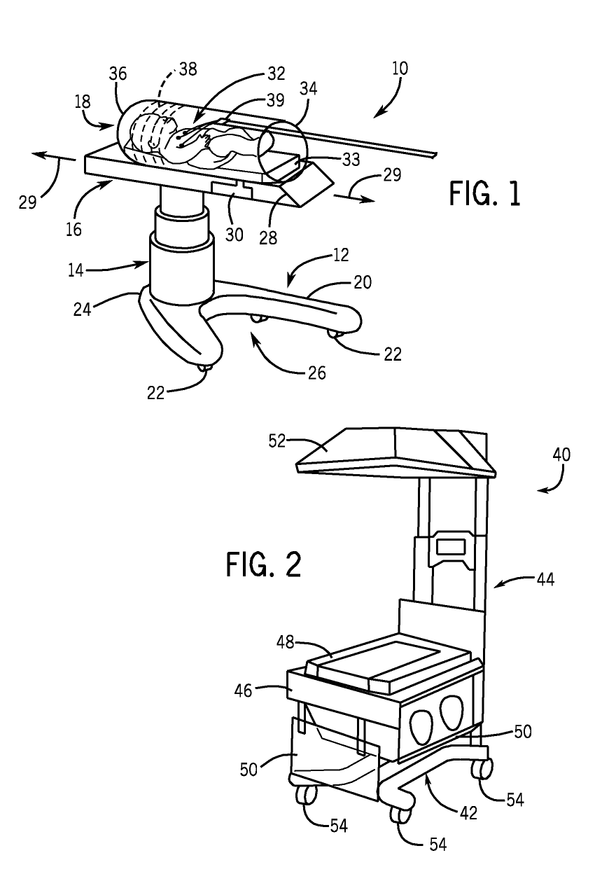

Referring to FIG. 1, an isometric view of an infant transporter 10 is shown in accordance with an embodiment. The infant transporter 10 is preferably MRI compatible. For purposes of this disclosure, the term MRI compatible should be defined to comprise a device that when used in the MR environment will present no additional risk to the patient and will not significantly affect the quality of the diagnostic information. Accordingly, the infant transporter 10 preferably eliminates or minimizes the use of magnetic material. The infant transporter 10 may comprise a transporter base 12, a support member 14, a transporter platform 16 and an infant housing 18.

The transporter base 12 may comprise a generally V-shaped base member 20 with a plurality of wheels 22. The V-shaped geometry of the base member 20 defines a truncated point 24 and a generally opposite aperture 26. The aperture 26 may be implemented to accommodate an infant incubator or hybrid incubator/warmer as will be described in more detail hereinafter. The V-shaped geometry is optional, and other geometries may be envisioned (e.g., U-shaped, square U-shaped, horseshoe shaped, etc.). The wheels 22 may be implemented to facilitate translation of the infant transporter 10.

The support member 14 is secured to and extends away from the transporter base 12. The support member 14 is preferably vertically adjustable and therefore may comprise a cylindrical telescoping geometry. This vertical adjustment may help accommodated any height differential between an infant's starting point (e.g., an incubator or incubator/warmer) and destination (e.g., an MRI bore).

The transporter platform 16 is secured to and supported by the support member 14. The transporter platform 16 is both large enough to accommodate an infant and small enough to be disposed within an MRI bore. The transporter platform 16 may optionally be translatable in a fore/aft direction relative to the support member 14 as indicated by arrows 29. In other words, the transporter platform 16 can slide along its major axis to extend further away from the support member 14 in either the fore or aft direction as shown by arrows 29. According to one embodiment, the transporter platform 16 comprises a tapered end portion 28. As will be described in more detail, the tapered end portion 28 may be implemented to facilitate the transition of an infant from one environment to another with minimal stimulation.

The transporter platform 16 is depicted with an optional schematically represented convective heater 30 pneumatically coupled with the housing 18. The heater 30 may alternatively comprise any known technology for generating heat such as, for example, a radiant heater. The heater 30 may alternatively be secured to or disposed within other infant transporter 10 components such as, for example, the support member 14 or the housing 18. The heater 30 can regulate the thermal environment within the housing 18 thereby minimizing the impact associated with transitioning an infant from the controlled environment of an incubator.

The housing 18 is secured to and supported by the transporter platform 16. The housing 18 may comprise a generally cylindrical shell composed of a non-magnetic material such as nylon or plastic. The housing 18 is adapted to circumscribe and retain an infant 32. The housing 18 may comprise a transporter mattress 33 so that the infant 32 can be retained with optimal comfort. The housing 18 may define an open end portion 34 and a generally opposite occluded end portion 36. The infant 32 may pass through the open end portion 34 such that her head is positioned near the occluded end portion 36.

The housing 18 may comprise a radio frequency (RF) coil 38 shown with dashed lines. The RF coil 38 may be disposed within the housing 18 at a location adapted to facilitate the imaging of a specific region or anatomy of interest. The RF coil 38 is configured to emit a radiofrequency enabling an MRI. The housing 18 may also comprise line management feature 39 adapted to organize any peripheral wires or tubing to the infant 32.

Referring to FIG. 2, a hybrid incubator/warmer 40 is shown in accordance with an embodiment. As will be appreciated by those skilled in the art, a great deal of care must be taken to avoid any unnecessary contact with an infant within the controlled environment of the incubator/warmer 40. If the infant must be transferred from the incubator/warmer 40 to conduct an MRI, the transfer should be as seamless as possible. The infant transporter 10 (shown in FIG. 1) will now be described in accordance with an embodiment as being adapted to facilitate the seamless transfer of an infant from the incubator/warmer 40 to an MRI device. It should be appreciated that the infant transporter 10 may alternatively be implemented with other devices such as, for example, an infant incubator (not shown).

The incubator/warmer 40 may comprise an incubator base 42, a vertical frame 44, an incubator platform 46, an incubator mattress 48, a plurality of incubator walls 50 and an incubator hood 52. The incubator base 42 may include one or more wheels 54 to facilitate translation of the incubator/warmer 40. The vertical frame 44 may be secured to and extend vertically away from the incubator base 42. The incubator platform 46 may be secured to the vertical frame 44, or may alternatively be secured to the incubator base 42. The incubator mattress 48 may be secured to and supported by the incubator platform 46.

One or more of the incubator walls 50 may be pivotably secured to the incubator platform 46. The incubator walls 50 can be pivoted between an up-position (not shown) and a down-position (shown in FIG. 2). In the up-position the incubator walls 50 surround an infant to at least partially define the incubator's controlled environment. In the down-position an infant disposed on the incubator mattress 48 is more accessible. It should be appreciated that the incubator walls 50 are generally placed in their down-position to facilitate the transfer of an infant to an MRI device.

The incubator hood 52 may be secured to the vertical frame 44. The incubator hood 52 may be vertically adjustable between a lowered-position (not shown) and a raised-position (shown in FIG. 2). In the lowered-position the incubator hood 52 engages the incubator walls 50 to enclose an infant within the controlled environment. In the raised-position an infant disposed on the incubator mattress 48 is more accessible. It should be appreciated that the incubator hood 52 is generally placed its raised-position to facilitate the transfer of an infant to an MRI device.

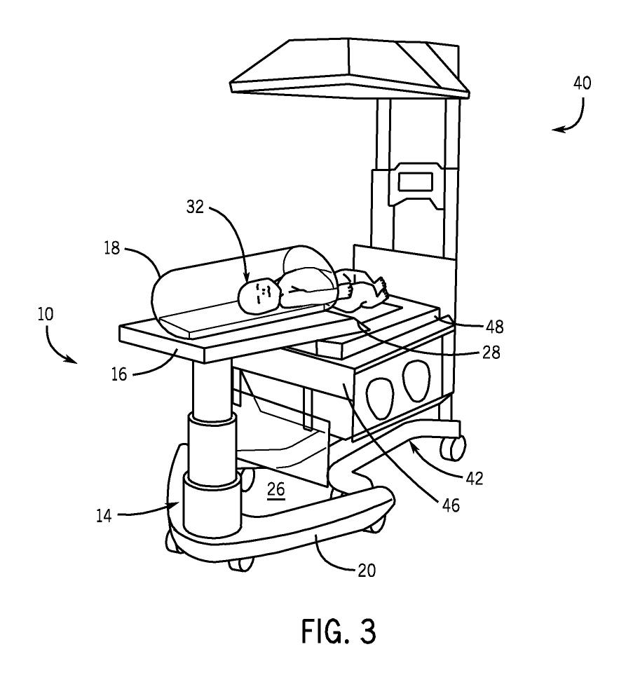

Referring to FIG. 3, the infant transporter 10 is depicted engaging the incubator/warmer 40 to transfer of an infant in accordance with an embodiment. As shown, the aperture 26 defined by the V-shaped geometry of the transporter's base member 20 may be implemented to at least partially accommodate the incubator base 42. In other words, the V-shaped geometry of the transporter's base member 20 may allow a user to bring the transporter platform 16 into close proximity with the incubator platform 46 to facilitate an infant transfer. The transporter platform 16 may also be translated in a fore/aft direction as indicated by arrow 29 (shown in FIG. 1) relative to the support member 14 in order to bring the transporter platform 16 closer to the incubator platform 46.

According to one embodiment, the transporter platform 16 may be translated underneath the infant 32 such that the infant 32 is transitioned from the incubator mattress 48 into the infant transporter's housing 18 without handling the infant 32. The optional tapered end portion 28 of the transporter platform 16 may be implemented to more seamlessly slide underneath the infant 32 and thereby minimize stimulation as the infant 32 is transferred from the incubator mattress 48 into the infant housing 18.

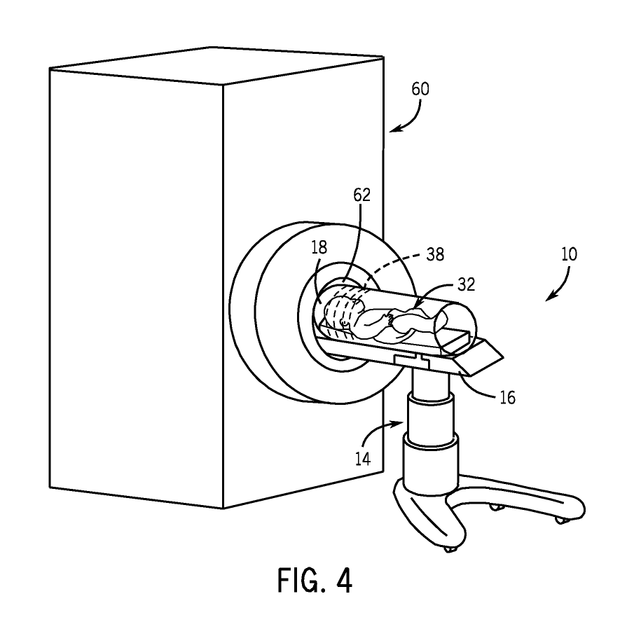

Referring to FIG. 4, the infant transporter 10 is shown transferring the infant 32 into an MRI device 60 in accordance with an embodiment. The transporter platform 16 may be translated in a fore/aft direction as indicated by arrow 29 (shown in FIG. 1) relative to the support member 14 in order to position the housing 18 and the infant 32 within the MRI bore 62. Positioning the infant 32 within the MRI bore takes place with minimal infant contact or stimulation which, as has been previously pointed out, is important for the infant's development. After the housing 18 is positioned within the MRI bore 62, the RF coil 38 can be implemented to emit a predefined radiofrequency enabling the MRI, and the MRI device 60 can image the infant 32.

Referring again to FIG. 3, after the MRI has been complete the infant transporter 10 can be translated into close proximity with the incubator platform 46 by accommodating the incubator base 42 within the aperture 26 defined by the transporter's base member 20. The transporter platform 16 may then be translated in a fore/aft direction as indicated by arrow 29 (shown in FIG. 1) relative to the support member 14 in order to bring the transporter platform 16 closer to the incubator platform 46. This close proximity of the transporter platform 16 and the incubator platform 46 facilitates the transition of the infant 32 from the infant transporter 10 back to the incubator/warmer 40 with minimal stimulation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An infant transporter comprising:
a transporter base;
a support member secured to the base; and
a housing supported by the support member, said housing being translatable relative to the support member;
wherein the infant transporter exclusively comprises components that are magnetic resonance imaging compatible.

2. The infant transporter of claim 1, wherein said transporter base defines a generally V-shaped geometry or a generally U-shaped geometry.

3. The infant transporter of claim 1, wherein said support member is vertically adjustable such that the housing can be raised and lowered.

4. The infant transporter of claim 1, wherein said housing defines a generally cylindrical geometry composed of a non-magnetic material.

5. The infant transporter of claim 1, wherein said housing comprises a radio frequency coil adapted to emit a radio frequency configured to enable magnetic resonance imaging.

6. The infant transporter of claim 1, wherein said housing comprises a line management feature.

7. The infant transporter of claim 1, wherein said housing is translatable in a manner adapted to extend further away from the support member in either a fore or aft direction.

8. The infant transporter of claim 1, further comprising a heater.

9. The infant transporter of claim 8, wherein the heater comprises a convective heater pneumatically coupled with the housing.

10. An infant transporter comprising:
a transporter base;
a vertically adjustable support member secured to the base;
a transporter platform secured to the support member, said transporter platform being translatable relative to the support member such that the transporter platform is extendable away from the support member in either a fore or aft direction; and
a housing supported by and secured to the transporter platform;
wherein the infant transporter exclusively comprises components that are magnetic resonance imaging compatible.

11. The infant transporter of claim 10, wherein said transporter base defines a generally V-shaped geometry or a generally U-shaped geometry.

12. The infant transporter of claim 10, wherein said transporter platform is translatable along its major axis.

13. The infant transporter of claim 10, wherein said transporter platform comprises a tapered end portion.

14. The infant transporter of claim 10, wherein said transporter platform comprises a heater.

15. The infant transporter of claim 14, wherein the heater comprises a convective heater pneumatically coupled with the housing.

16. The infant transporter of claim 10, wherein said housing defines a generally cylindrical geometry composed of a non-magnetic material.

17. The infant transporter of claim 10, wherein said housing comprises a line management feature.

18. The infant transporter of claim 10, wherein said housing comprises a radio frequency coil adapted to emit a radio frequency configured to enable magnetic resonance imaging.
